(19) United States
(12) Patent Application Publication
(10) Pub. No.: US 2003/0189308 A1
(43) Pub. Date: Oct. 9, 2003

(54) Custom bicycle frame

(76) Inventors: Stephen Joseph Wegzyn, Tampa, FL (US); Robert Bruce Lahm, Safety Harbor, FL (US)

Correspondence Address: Stephen J. Wegzyn, 9959 Stockbridge Dr., Tampa, FL, 33626, US

(21) Appl. No.: 10/116,907

(22) Filed: Apr. 8, 2002

(51) Int. Cl. B62K 1/00

(52) U.S. Cl. 280/281.1

(57) ABSTRACT

A bicycle frame comprised of a lightweight composite panel all of common thickness for simplicity of shaping desired by the user. Attached to the panel is a steering column, which is formed to receive a head set, a front fork, a handlebar and wheel. Also attached to said panel, is a chain stay member that has two supporting brackets, and a seat support assembly that can adjustably support a seat tube with an attached seat.

### BACKGROUND THE INVENTION

1. Field of the Invention

The present invention relates to a new and improved bicycle frame comprised of a lightweight composite main panel of a common thickness for simplicity of shaping as desired by a user. In particular, the invention relates to a bicycle frame of composite layers having an interior core, the core being a lightweight material or honeycomb, sandwiched between layers of reinforcing material that are bonded together.

2. Description of the Prior Art

A variety of non-tubular bicycle frames have been designed in the past. These frames feature a wide range of materials, innovative designs, and cross-sections.

Traditional tubular bicycles utilized hollow steel tubes that were brazed together to form a design that created the support structure for the rider. This design has been improved over the years, steel tubes were replaced with aluminum, titanium and carbon fiber. Brazing was replaced with welding and gluing. Round tubes were replaced with oval elongated shapes that improved the aerodynamics of the conventional frame. Even with these improvements, the tubular frame maintains many of the two triangle forms of the conventional steel framed bikes of the past.

To further improve the Bicycle, designers utilized composites to greatly improve the aerodynamics of the frame. The composite frame material has a lower density, higher specific strength and good dampening. The prior art patents listed disclose a variety of non-tubular bicycle frames. Colegrove discloses honeycomb structures and composite materials. Fritschen discloses exterior layers with reinforcement there between. Porsche discloses one-piece frames of various shapes. Nothing in the prior art teaches or suggests the present invention of a frame of composite layers all of common thickness for simplicity of shaping a frame as desired by a user.

### SUMMARY OF THE INVENTION

The present invention is an innovative new bicycle frame that consists of a flat panel of composite layers that is attached to a steering column and extends to a seat support assembly and a chain-stay assembly. The flat panel functions as the only support between the steering column, seat support and rear chain-stay assembly that supports the rear wheel.

The present invention is a new and improved design that features a flat composite panel. The panel has a common thickness. The composite panel components could be pre-cut then joined or the panel could be fabricated from a pre-layered composite sheet that is worked to the desired shape. The layers of the panel could be comprised of any number of suitable metallic or nonmetallic materials with desirable characteristics such as extremely strong, light weight, with good flex resistance. Some materials that could be used for the panel are carbon fiber, Kevlar, fiberglass, aluminum, aluminum honeycomb, balsa wood, plastic or other materials. The edge of the shaped composite can be left as formed, fit with a skin material or sealed by other means. The flat surface of the panel offers a large area for graphics and text. The fact that the panel is flat also allows the fabricator to easily change the edge shapes and curves to further customize the bicycle frame to the users requirements.

This bicycle consisting of a flat panel attached to the steering column, seat support, and rear chain stay. It is easy to customize, construct and assemble. Other advantages of the invention will be apparent from the following description of preferred embodiments of the invention as illustrated in the accompanying drawings.

### BRIEF DESCRIPTION OF THE DRAWINGS

The drawings constitute a part of the specification and include general embodiments of the present invention, including the following;

FIG. 1 is a side view of a bicycle frame having a one-piece main member, front fork assembly, seat assembly and bottom bracket assembly.

FIG. 2 is a side exploded view of the one-piece main member with the internal honeycomb core cross-section illustration.

FIG. 3 is a view of the honeycomb core.

FIG. 4 is a side view of the various layers that make up the one-piece main member.

FIG. 5 is a side view of the chain stay that connects the back wheel to the main member.

FIG. 6 is a top view of the chain stay that shows the shape of the two pieces that encompass this part of the bicycle.

FIG. 7 is a top view of the seat assembly.

FIG. 8 is a side view of the seat assembly.

FIG. 9 is a side view of the front fork.

FIG. 10 is a top view of the front fork.

FIG. 11 is a side view of the crank bottom bracket mount and chain stay internal support.

FIG. 12 is a top view of the crank bottom bracket mount and chain stay internal support.

### DETAILED DESCRITION OF THE INVENTION

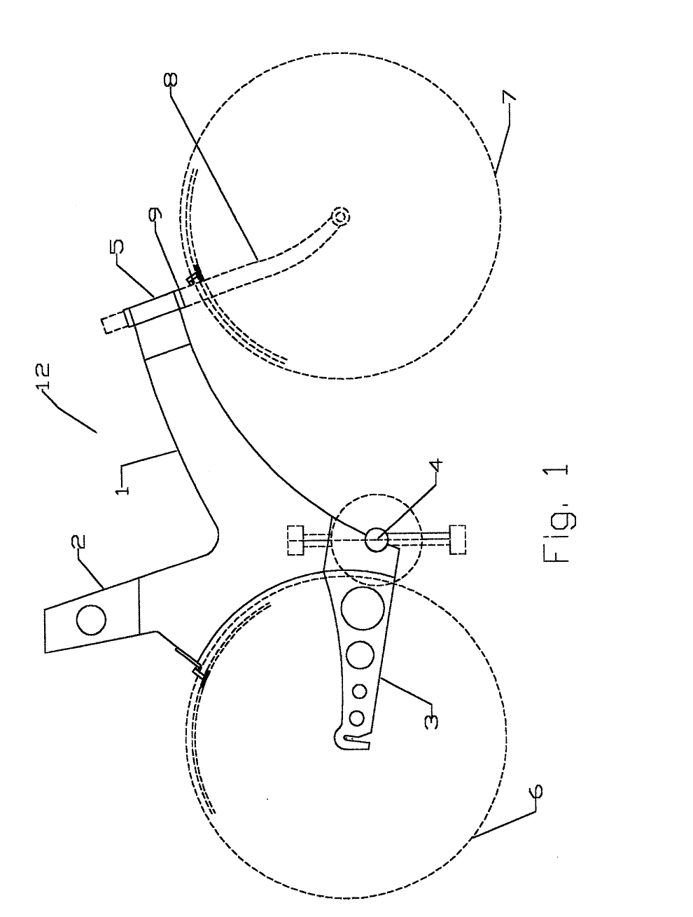

FIG. 1 illustrates a bicycle frame 12. The main portion of the bicycle frame is formed out of a composite sheet 1 of uniform thickness. The composite frame sheet 1 consists of an aluminum honeycomb core 13 sandwiched between two thin sheets 14 and 15 consisting of aluminum, carbon fiber, Kevlar or other light strong material. The sheets are bonded with common two-part epoxy adhesive. The edges of the sheet 1 is sealed two ways, they are filled with a hardening putty material such as Bondo then sanded flat, or a thin strip of flexible material such as aluminum, plastic, or Kevlar is glued with two part epoxy. The composite sheet 1 can be cut from a larger sheet of composite with a CNC milling machine or the layers 13, 14, and 15 can be pre-cut then glued.

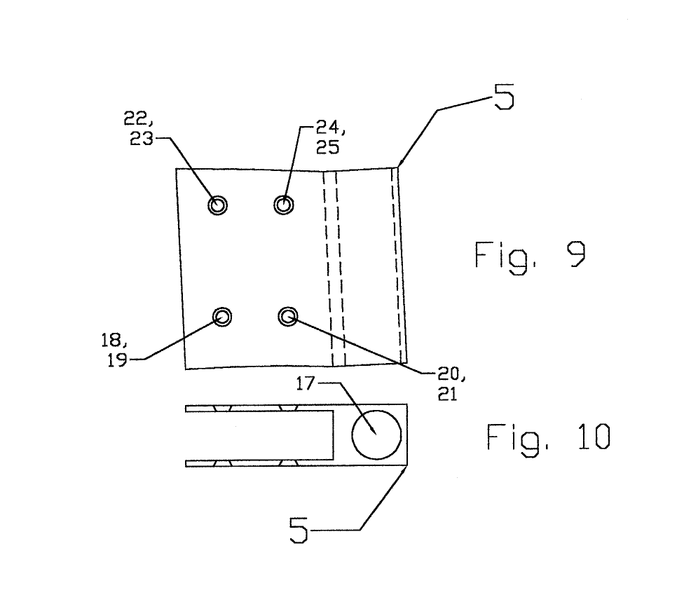

Attached to the front of the mainframe portion 1 is the front steering column 5. The steering column 5 is machined one piece out of a light weight strong material. Holes 18, 19, 20, 21, 22, 23, 24, and 25 are machines into the piece to allow it to be attached to the main frame portion 1 with flat head screws. The screws are inserted through the steering column piece 5 (see FIG. 9.) into the internally threaded aluminum rods 26, 27, 28, 29 that are glued into holes in the main frame piece1. Hole 17 is machined into 5 to allow a common handlebar (not depicted), headset 9, the front fork 8, and the front wheel 7 to be attached to the bicycle frame.

The seat assembly 2 is made of three pieces the seat post clamp 36, and the two supporting sides 40 and 41. These three pieces are machined from lightweight strong material. The assembly 2 attaches to the main frame piece 1 similarly as the front steering column 5 does. The assembly 2 is attached with two flat head screws on each side of the frame, total of four screws, that are inserted into internally threaded aluminum rods 30 and 31 that are glued with two-part epoxy into the main frame piece 1. A common seat with cut down seat post, per the rider's requirement, is inserted and clamped into place with the seat post clamp 36 that is attached to the seat post assembly with three screws inserted into locations 37, 38, and 39.

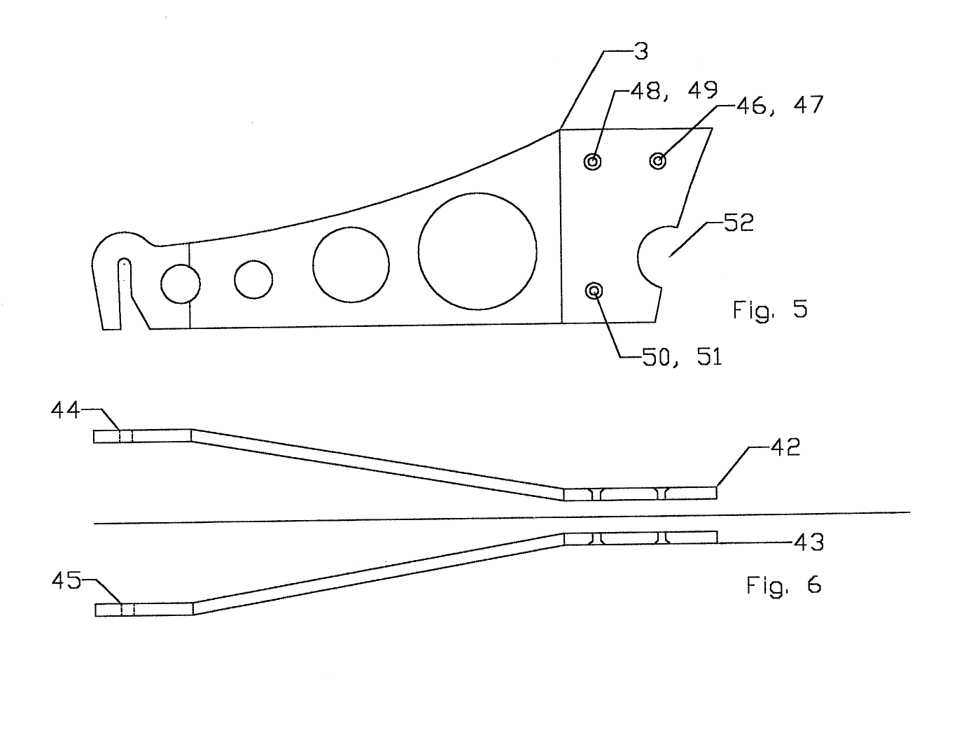

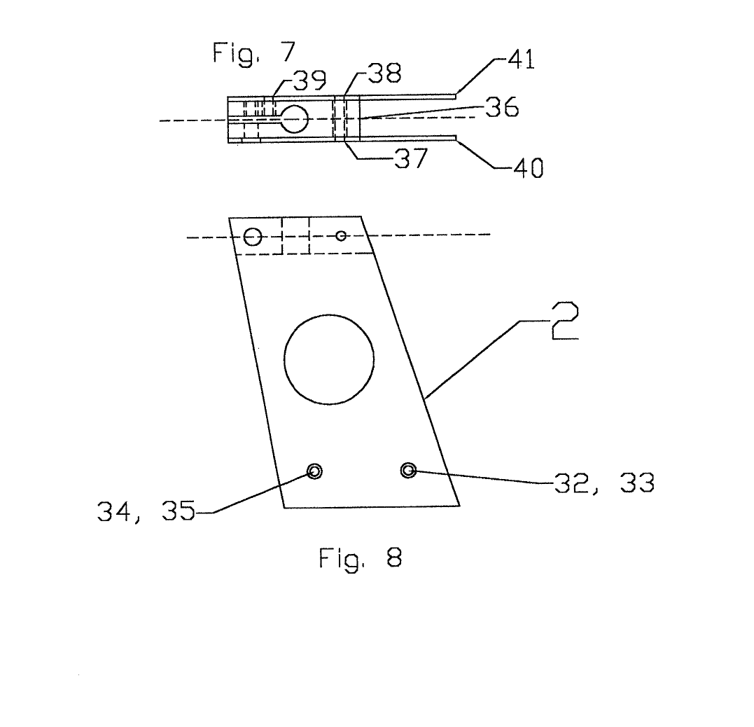

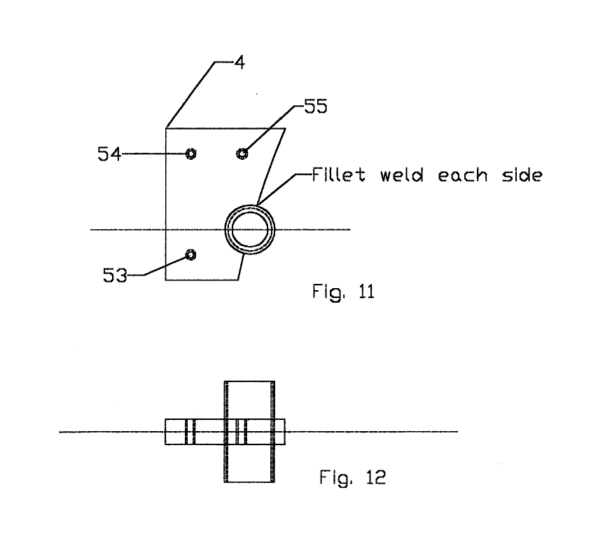

The chain stay 3 shown in FIG. 5 and FIG. 6 effectively attaches the rear wheel 6 to the main frame piece 1. The chain stay 3 consists of a pair of brackets 42 and 43. These pieces 42 and 43 are machines from a sheet of light weight strong material. Slots 44 and 45 are machined in the chain stay pieces to allow the rear wheel 6 to be attached to 3. Six holes 46, 47, 48, 49, 50 and 51 are drilled through the pieces 42 and 43. These holes align with the bottom bracket chain stay support threaded holes 53, 54 and 55 shown in FIG. 11 and FIG. 12 that correspond with the holes 56, 57 and 58 in the main frame piece 1.

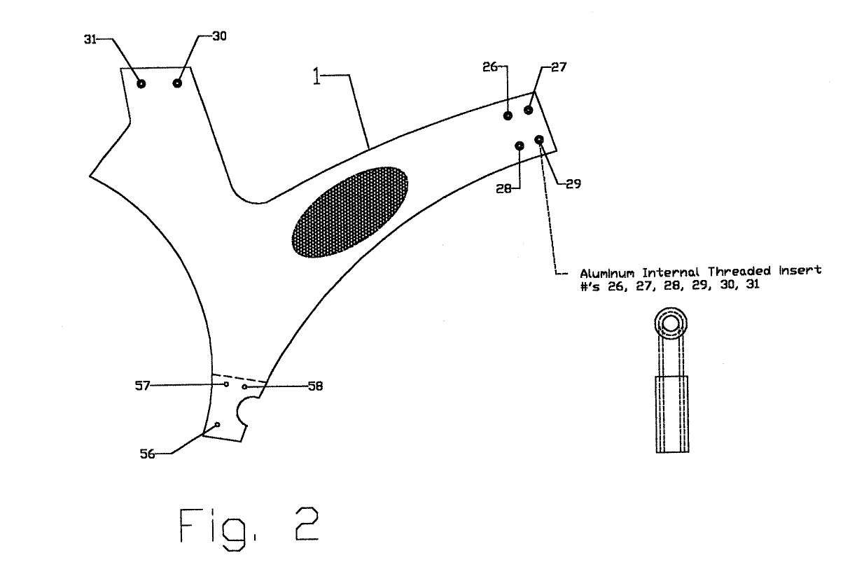

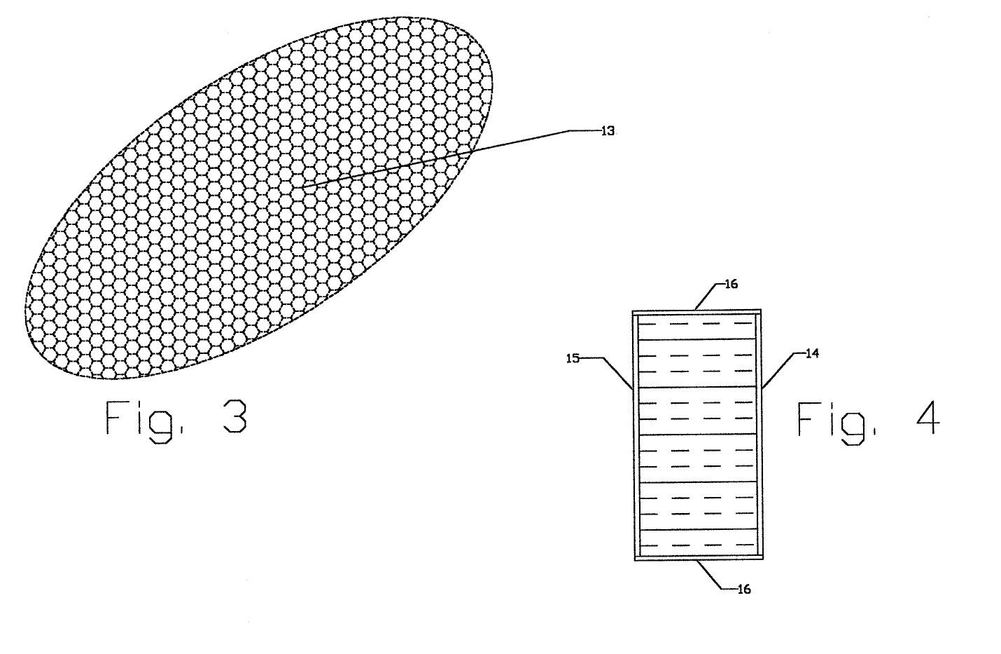

The bottom bracket chain stay support 4 is inserted and glued with two part epoxy between the outer layers of the main frame section 1 where the internal honeycomb material has been removed (depicted by the dotted line area on FIG. 2. The support 4 is inserted such that the holes 53, 54, and 55 are visible in the holes 56, 57, and 58 respectively. The chain stay 3 pieces 42 and 43 are attached to the main frame piece 1 with screws that are inserted through the chain stay into the frame piece.

This invention lends itself to many customizing features that are not available on other bikes. All excess material should be removed from all components of the frame to help minimize the weight of the frame. This is depicted by the holes machined through the chain stay pieces 42 and 43 and the seat support 2. This material removal does not have to be limited to the depicted areas and patterns as shown. Some material can be removed from the main frame piece 1 by machining holes or patterns (names etc.) in the frame member. The edges of these holes would be filled as the outside edges explained above. This material removal can be done such that the requester has a custom one of a kind bike Excessive material should not be removed as to prevent the frame design to support a riders weight under expected operation. To further customize per the requester, the outer edge of the main frame piece 1 can also be easily adjusted to the riders desire and the edge shape can be blended into the current or adjusted edge shapes of the seat post 5, the bottom bracket 3, and the seat support 2. This frame design can be finished in a number of different methods as desired, the materials can be clear coated to show the Kevlar, Carbon Fiber, Aluminum or other raw material the frame is constructed from. It can be anodized if constructed from Aluminum. It can be powder coated or painted. The high surface area created by the design is ideal for large logos painting and screenings that are not available on the average tubular frame and many of the composite frames.

There is a wide range of designs and configurations of bicycle frames. Thus, specific details of the invention as disclosed herein are not to be interpreted as limiting the scope of the invention, but simply provides a basis for the claims and for teaching one skilled in the art to variously practice and construct the present invention in any appropriate manner. Changes may be made in the details of the construction of the bicycle frame, and in individual steps of the method of fabricating such a frame member, without departing from the spirit of the invention, especially as outlined in the following claims.

What is claimed is:

1. A bicycle frame constructed from a main flat panel of common thickness which is comprised of a core that is sandwiched with between thin flat sheets of material that are all held together with adhesive, the edges of the said panel are sealed with sheets of thin material that are bonded on, said panel has attached to it a chain stay member that has two supporting brackets, a steering column which is formed to receive a head set a front fork, a handlebar and wheel, and a seat support assembly that can adjustably support a seat tube with an attached seat.

2. A bicycle frame according to claim 1, wherein the side of the panel is sealed with a hardening filler material.

3. A bicycle frame according to claim 1, wherein the core requires no edge sealing method yet provides desirable properties for a bicycle.

4. A bicycle frame according to claim 1, wherein the core is one material and requires no laminate material attached to it.

5. A bicycle frame according to claim 1 or 2 or 3, wherein the outer flat sheets are Kevlar.

6. A bicycle frame according to claim 1 or 2 or 3, wherein the outer flat sheets are Aluminum.

7. A bicycle frame according to claim 1 or 2 or 3, wherein the outer flat sheets are Carbon Fiber or other light material.

8. A bicycle frame according to claim 1, wherein the base of the main flat panel has a common thickness but has added material on the sides.
